(19) United States
(12) Patent Application Publication
(10) Pub. No.: US 2009/0212145 A1
(43) Pub. Date: Aug. 27, 2009

(54) Collapsible shredder base

(76) Inventors: Simon Huang, Taipei (TW); Herman Chang, Palos Verdes Peninsula, CA (US)

Correspondence Address: Venable, 2049 Century Park East, 21st Floor, LOS ANGELES, CA, 90067, US

(21) Appl. No.: 12/072,053

(22) Filed: Feb. 23, 2008

(51) Int. Cl. B02C 23/00

(52) U.S. Cl. 241/285.2

(57) ABSTRACT

The present invention discloses a shredder base capable of collapsing into one flat piece in order to reduce the amount of space occupied when shipping or storing the shredder base. A shredder base having features of the present invention comprises four side walls with reinforcing members located at each upper corner of the shredder base. Each reinforcing members has a hinge which allows for the base to collapse and fold onto itself. The bottom wall of the shredder base has two upper support flaps and a lower folding bottom wall. In other preferred embodiments, a base frame is comprised of legs which are attached to a shredder housing support frame via hinges. The legs may also be connected to a bottom support for increased stability.

### BACKGROUND OF THE INVENTION

1. Field of the Invention

The present invention relates generally to shredder bases. Specifically, this invention discloses a shredder base capable of collapsing in order to reduce the amount of space occupied when shipping or storing shredders.

2. Background Information

With increased privacy concerns shredders have become an integral part in both homes and businesses. Though originally used to destroy paper products, shredders are now used for other forms of media that hold information, such as compact discs. In addition, credit cards and other plastic products are commonly shredded.

Material that is shredded accumulates in the base of the shredder which is typically cylindrical or box shaped and made of a rigid material. When transporting or storing shredders, it is common to place the shredder housing in the shredder base. The space occupied by the shredder in transit or storage is thus the space taken up by the shredder base.

Prior applications such as U.S. Ser. No. 10/706442 have sought to improve the storage and transportation issue of waste baskets by disclosing cylindrical waste baskets which can be disassembled into at least two components: a side wall and bottom. When disassembled, these two components can lay flat, thus reducing the amount of space occupied. However, such baskets require the assembly of at least two separate components prior to use.

The present invention seeks to minimize the amount of space taken by a shredder base while at the same time simplifying assembly. In one preferred embodiment, a shredder base, as disclosed herein, is made up of one piece which can fold up onto itself. In the folded configuration, the shredder base is flat, thus reducing the amount of space occupied. In other embodiments, the shredder base is comprised of a base frame which supports a shedder bag. The base frame can collapse to reduce space. Shipping and transportation costs are thus decreased. In addition, this improved shredder base gives the manufacturer the option of packaging multiple, different sized bases with each shredder housing without increasing transportation costs.

Full assembly of the shredder base is simply done by unfolding the base or base frame. Since the shredder housing, which holds the shredding mechanism, is heavy, the shredder base may have reinforcements which support the shredder housing. This reinforcement system in the base can thus ensure that the shredder housing is properly secured.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a collapsible shredder base that can be readily assembled. In one preferred embodiment, a shredder base having features of the present invention comprises four side walls with reinforcing members located at each upper corner of the shredder base. Each reinforcing member has a hinge which allows for the base to collapse and fold onto itself. The bottom of the shredder base has two upper flaps secured to two lower folding flaps.

In other preferred embodiments, a shredder base having features of the present invention comprises a base frame which supports a shedder bag. The base frame is comprised of legs which are attached to a shredder housing support frame via hinges. The legs may also be connected to a bottom support for increased stability.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a perspective view of a shredder base and housing embodying the features of this invention.

FIG. 2 is a perspective view of a shredder base and housing embodying features of this invention.

FIG. 3 is a perspective view of a shredder base and housing embodying features of this invention.

FIG. 4 is a top view of a shredder base embodying features of this invention.

FIG. 5 is a top view of a shredder base embodying features of this invention.

FIG. 6 is a bottom view of a shredder base embodying features of this invention.

FIG. 7 is a perspective view of a folded shredder base embodying features of this invention.

FIG. 8 is a perspective view of multiple folded shredder bases and a shredder housing embodying features of this invention.

FIG. 9 is a perspective view of a shredder base frame embodying the features of this invention.

FIG. 10 is a perspective view of a folded shredder base frame embodying features of this invention.

FIG. 11 is a perspective view of a shredder base frame embodying the features of this invention.

FIG. 12 is a perspective view of a folded shredder base frame embodying features of this invention.

FIG. 13 is a perspective view of a shredder base frame embodying the features of this invention.

FIG. 14 is a perspective view of a folded shredder base frame embodying features of this invention.

### DETAILED DESCRIPTION OF THE INVENTION

The essential elements of a shredder are comprised of a housing 1, a shredder mechanism which resides in the housing, and a base 2. The shredder mechanism can be of any sort commonly known to those skilled in the art and is thus not described herein.

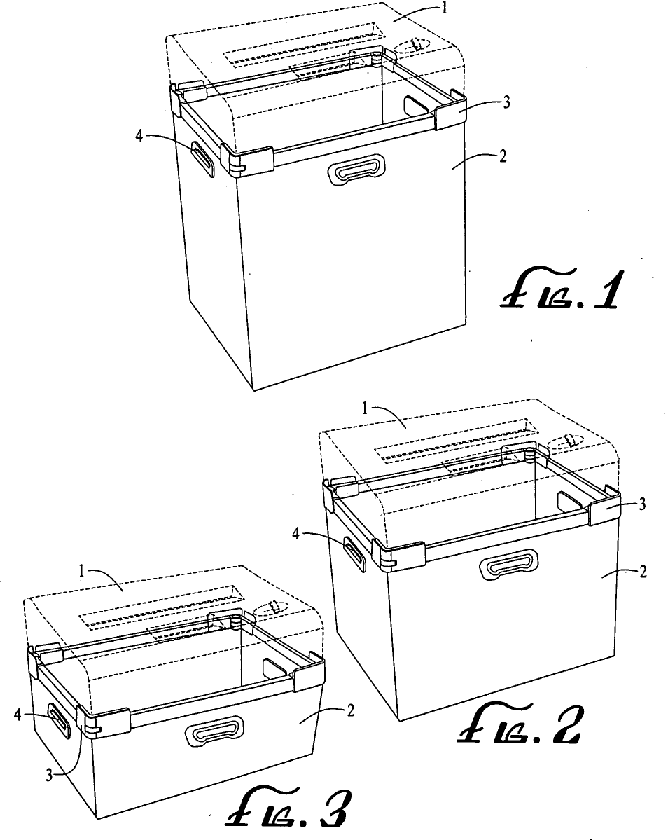

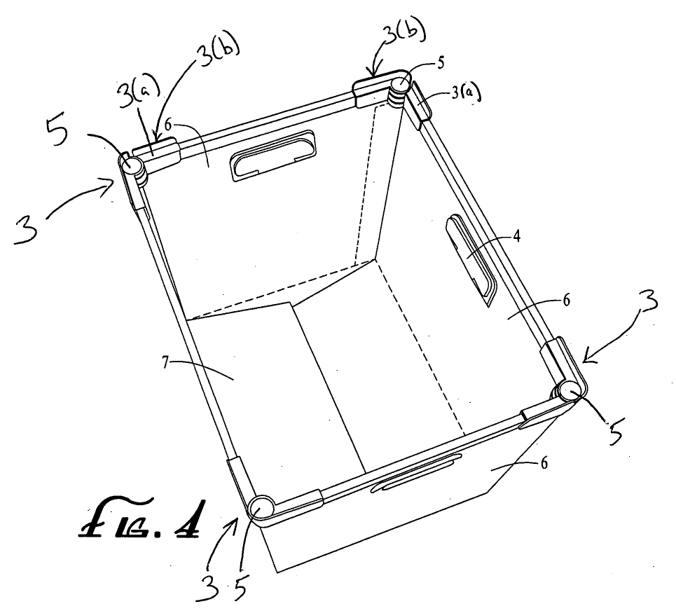

In one preferred embodiment, a shredder base is made up of one piece that collapses onto itself. The collapsible shredder base occupies less space when packaging, thus allowing manufacturers to transport multiple shredder bases with one shredder housing at the same transportation cost (or less) than shipping a conventional shredder housing and base. As seen in FIGS. 1-3, multiple sized shredder bases can be used with the same sized shredder housing, thus providing the end-user with options in terms of the base size. The base 2 may also have a handle 4 to help a user carry the shredder.

FIG. 4 discloses a base 2 with a bottom wall and four side walls 6 with four reinforcing members 3 in each upper corner of the base 2. The reinforcing members 3 have a platform 3a and side wall 3b which provide support for the shredder housing. The reinforcing members also have a hinge 5 which facilitate folding of the base 2.

It should be appreciated that although this preferred embodiment discloses four reinforcing members in each upper corner of the base, any number of reinforcing members may be used along the top of the base in order to provide support for the shredder housing, or one continuous reinforcing member can run along the top of the base. In addition, although this preferred embodiment discloses a hinge in each corner of the base, a simple break in the reinforcing member at each corner can be used rather than a hinge.

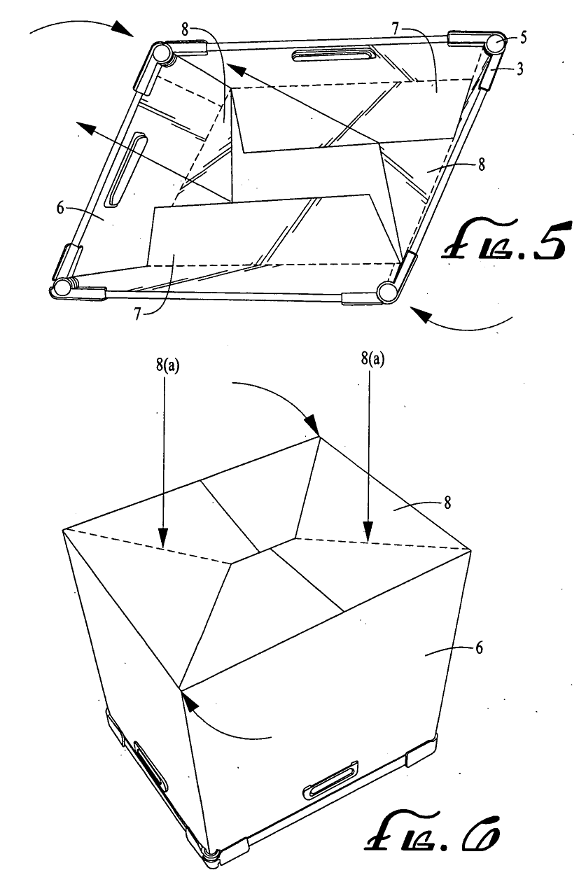

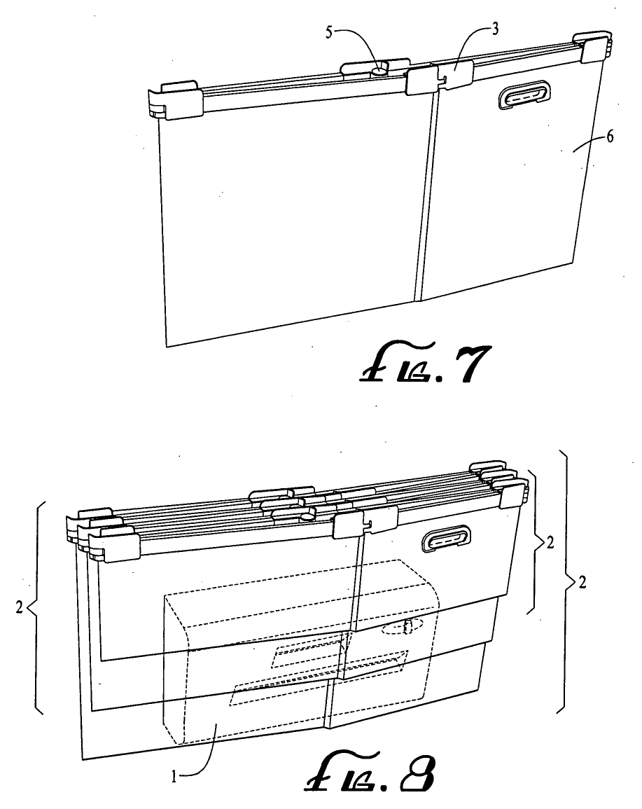

FIGS. 5 and 6 illustrate how the base 2 is capable of collapsing upon itself. In the assembled position, two upper support flaps 7 of the bottom of wall lie flat against the two lower folding flaps 8 of the bottom wall. When collapsing the shredder base, the two upper support flaps 7 fold up towards the side walls while the two lower folding flaps 8 fold in along lines 8(a). As the upper and lower flaps fold, the shredder base sides 6 also fold along the axis of the reinforcing member hinge 5. As seen in FIG. 7, when the shredder base 2 is fully collapsed it is comprised of one unitary flat piece. FIG. 8 illustrates the packaging of 3 different sized collapsible shredder bases with a shredder housing.

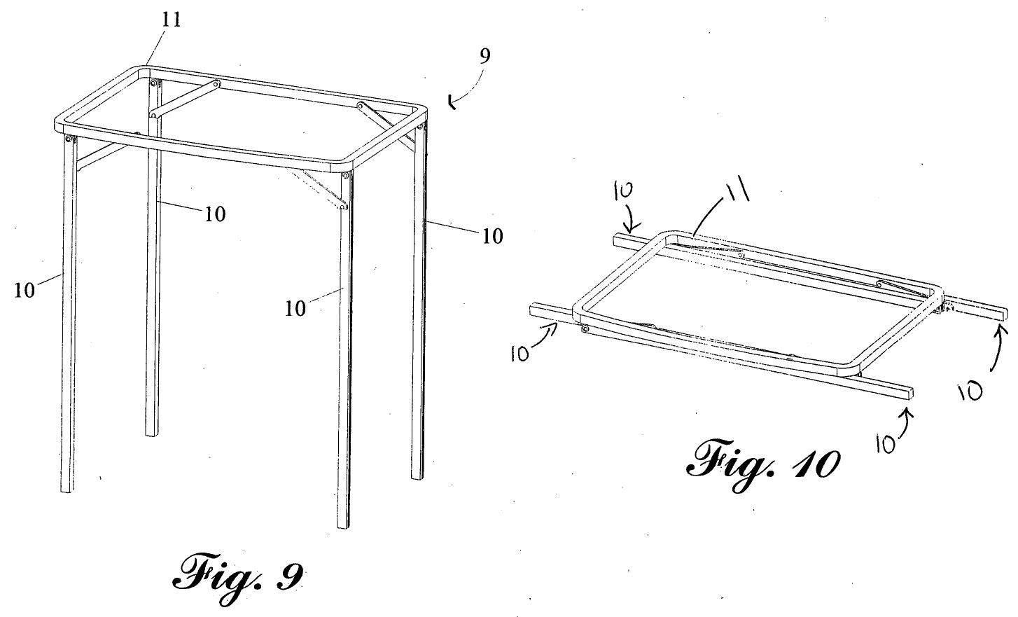

FIGS. 9 and 10 disclose another preferred embodiment comprised of a base frame 9 which supports a shedder bag (not shown). The base frame 9 is comprised of legs 10 which are attached to a shredder housing support frame 11 via hinges. During transit or storage, the legs 10 can fold up against the housing support frame 11. Although FIGS. 9 and 10 disclose four legs, it should be appreciated that three legs or more may be used to form a base.

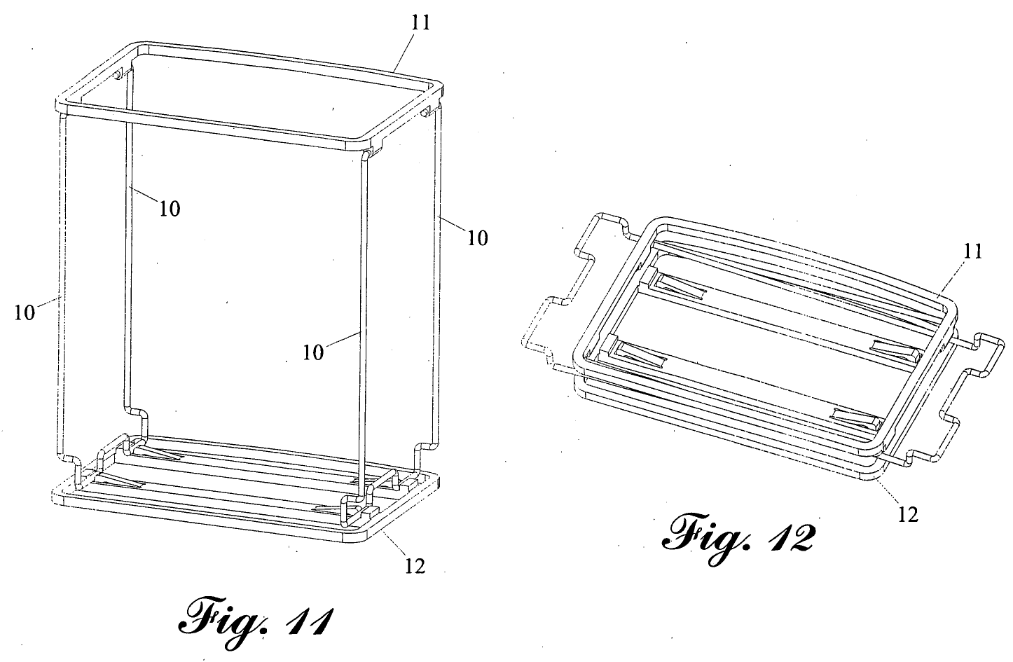

FIGS. 11 and 12 disclose another preferred embodiment in which the legs 10 are attached to a housing support frame 11 and also attached to a bottom support 12 for increased stability. The connection to the bottom support may be made by any mechanism known to those skilled in the art such that the legs are locked into place when the base frame is open. This embodiment collapses such that legs 10 fold in between the housing support frame 11 and the bottom support 12.

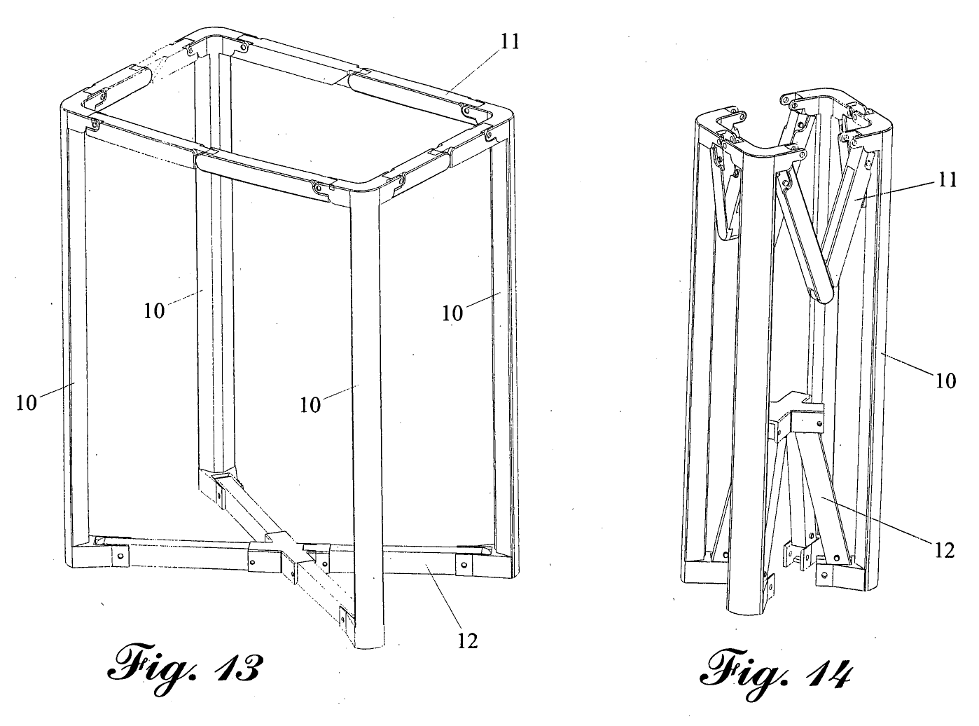

FIGS. 13 and 14 disclose another preferred embodiment in which the legs 10 are directly connected to each other by a bottom support 12. In this embodiment the shredder housing support 11 and the bottom support 12 have hinges which connect housing support 11 and the bottom support 12 to the legs 10, as well as hinges between each support segment. This allows the base frame to collapse upon itself.

Although the present invention has been described in detail with respect to certain preferred versions thereof, other versions are possible. Therefore, the scope of the claims should not be limited to the description of the preferred versions contained herein.

1. A shredder comprised of:
(a) a housing;
(b) a shredder mechanism;
(c) a base with four side walls and a bottom wall, said base capable of collapsing; and
(d) a reinforcing member at the top of said base for supporting said housing.

2. The shredder of claim 1 wherein said bottom wall has two upper support flaps and two lower folding flaps.

3. The shredder of claims 2 or 3 wherein said reinforcing member has a hinge which facilitate folding of the base.

4. A shredder comprised of:
(a) a housing;
(b) a shredder mechanism; and
(c) a base frame with at least three legs attached to a shredder housing support frame, said legs capable of folding.

5. The shredder of claim 4 wherein said legs are also attached to a bottom support.
